(19) United States
(12) Patent Application Publication
(10) Pub. No.: US 2015/0217241 A1
(43) Pub. Date: Aug. 6, 2015

(54) DISPENSERS

(71) Applicant: BUZZ TRADING 197 (PROPRIETARY) LIMITED, Johannesburg (ZA)

(72) Inventor: Peter James Buchan, Johannesburg (ZA)

(73) Assignee: BUZZ TRADING 197 (PROPRIETARY) LIMITED, Johannesburg (ZA)

(21) Appl. No.: 14/424,690

(22) PCT Filed: Sep. 2, 2013
(86) PCT No.: PCT/IB2013/058222

§ 371 Date: Feb. 27, 2015

(30) Foreign Application Priority Data
Aug. 31, 2012 (ZA) 2012/06547

(51) Int. Cl. B01F 1/00; C02F 1/68; C02F 1/50

(52) U.S. Cl. CPC B01F 1/0027; C02F 1/50; C02F 1/68; B01F 2001/0055; B01F 2001/0072; C02F 2305/00

(57) ABSTRACT

The invention provides a dispenser to dispense, in operation, particulate, soluble chemical agent, by dissolution, from a compacted or compressed harm thereof, into liquid that flows along a flow path. The dispenser comprises a body defining a liquid treatment chamber, an inlet to the liquid treatment chamber, through which inlet feed liquid can, in operation, continuously be ted into the treatment chamber, and an outlet from the treatment chamber, through which outlet product liquid, containing dissolved chemical agent can, in operation, continuously leave the treatment chamber. The dispenser is configured such that a chemical agent artefact comprising the particulate, soluble chemical agent in a compacted or compressed form is arrangeable in the dispenser, in use in a predetermined position in which the artefact is exposed to or accessible from inside of the treatment chamber only along a liquid contact surface provided by part of an outer surface thereof, which part extends along an artefact access plane defined in the dispenser in use at the predetermined position, such that liquid which is fed to the treatment chamber through the inlet, in operation, can contact the artefact only along the liquid contact surface and necessarily by passing across the artefact access plane.

### FIELD OF THE INVENTION

THIS INVENTION relates to dispensers. More particularly, the invention relates to dispensers to dispense, by dissolution, particulate, soluble chemical agents from a compacted or compressed form thereof into a liquid flowing along a flow path. The invention provides a dispenser and extends to a dispenser kit and to a dispenser assembly. The invention also provides a chemical agent dispensing system and a method of dispensing, by dissolution, a particulate, soluble chemical agent from compacted or compressed form thereof into liquid flowing along a flow path. The invention also extends to the dispenser in use and in operation. Also, the invention provides a chemical agent artefact comprising particulate, soluble chemical agent in compacted or compressed form.

### BACKGROUND TO THE INVENTION

Dispensing, by dissolution, particulate, soluble chemical agents from a compacted or compressed forms thereof into liquids flowing along a flow path is generally problematic. In particular, in the applicant's experience, it is difficult to achieve gradual and even dissolution of chemical agent from such forms of chemical agents and to avoid profile leaching, premature structural disintegration, overdosing, and the like.

In terms of calcium hypochlorite as chemical agent: Calcium hypochlorite is an effective and extremely versatile disinfectant. Its unique chemical structure delivers several benefits over other chlorine carriers. For instance, it is highly active in solution and is more concentrated and more effective than liquid chlorine. It is also pH stable, less corrosive than liquid chlorine and non-phytotoxic. Further, calcium hypochlorite is safer to transport, store and handle than chlorine gas. When used in solution, calcium hypochlorite is also less expensive and more effective than many other disinfectants. Additionally, since it consists of calcium and other innocuous salts and is highly soluble, calcium hypochlorite does not leave problematic residues.

Despite these advantages, the number of applications in which calcium hypochlorite is used is limited in relation to other chlorine carriers. The reason for this is twofold: Firstly, calcium hypochlorite, as mentioned, is highly soluble and its dissolution rate can be erratic depending on the source of the raw calcium hypochlorite material and/or the method employed in dispensing it. This is valid for both granular and tablet forms of calcium hypochlorite and complicates calcium hypochlorite dispensing, resulting in a relatively limited range of calcium hypochlorite dispensing dispensers being available. This difficulty in relation to calcium hypochlorite dispensing is relevant particularly in pressure lines, in which direct inline dispensing of calcium hypochlorite raw material typically results in the calcium hypochlorite, particularly when in the form of a calcium hypochlorite artefact e.g. a tablet, being eroded aggressively by the pressurised water flow. In some cases, the raw material remains immersed or at least in contact with the water when the pressure is relaxed, in which cases the calcium hypochlorite continues to dissolve, releasing excess chlorine into the water. In cases in which the raw calcium hypochlorite material is exploited in tablet form, such continued dissolution compromises the physical integrity of the tablet and results in overdosing and rapid dissipation of the calcium hypochlorite.

In the Applicant's experience, most calcium hypochlorite dispensing dispensers that are available on the market typically approach the abovementioned difficulties associated with calcium hypochlorite dispensing, particularly into pressure lines, in the following ways:
(i) One approach is to design the dispensers in such a way that most of the raw material remains dry during operation. Such dispensing dispensers require a self-draining line to operate effectively, however, thus rendering them unsuitable for use in most pressurised applications.
(ii) Another approach is to withdraw a branch water stream from a pressurised line carrying a main water stream that is to be treated with calcium hypochlorite and then to release the pressure on the branch water stream, typically bringing it to atmospheric pressure, e.g. by pumping it into a treatment vessel, treating the water of the branch water stream with calcium hypochlorite at atmospheric pressure, and then reintroduce the product water into the main stream under pressure, e.g. with a pump or venturi, thereby to treat the main water stream.
(iii) Another approach comprises the use of a combination of approaches (i) and (ii).

In the applicant's experience, none of the abovementioned approaches allows for calcium hypochlorite raw material to be dispensed directly, at a steady level and over longer periods of time, into a highly pressurised water line whilst at pressure, with the calcium hypochlorite raw product never being exposed to the full pressure of the pressurised line according to these approaches. This is particularly a concern in pressure lines operating at 4 bar or higher, for which the abovementioned approaches are not efficient or effective. The Applicant has therefore identified a need to provide for accurate, controlled, long term dispensing of calcium hypochlorite into pressure lines, in particular, but also in general.

A further concern in relation to inline calcium hypochlorite dispensing approaches in relation to pressure lines, particularly when using calcium hypochlorite in tablet form, is increased water-flow-driven erosion of the tablet due to the pressure of the water to which it is exposed. This necessarily reduces the operative lifetime of the tablet. Conventional inline dispensing approaches are, for this reason, ineffective in cases where long-term calcium hypochlorite dispensing is required.

Secondly, calcium hypochlorite is classified as a Class 5.1, Danger Group II Oxidiser and, as such, it is extremely problematic to ship by sea or air, store in bulk and display at retail level due to international hazardous cargo and warehousing guidelines. This fact alone has also, in the Applicant's experience, limited the number of participants in calcium hypochlorite marketing and technology development throughout the world.

The present invention seeks to address the abovementioned difficulties and concerns associated with calcium hypochlorite dispensing. As alluded to, however, difficulties similar to the abovementioned difficulties faced in calcium hypochlorite dispending are faced in dispensing other soluble particulate chemical agents, such as pH-control agents. The present invention therefore seeks also to address such difficulties.

Generally speaking, the invention seeks to provide an alternative approach to dispensing soluble chemical agents, including water treatment agents, pH control agents and fertilizers, from compacted or compressed forms thereof, into liquid, and particularly water, streams to be exploited as a solution of that chemical agent.

### SUMMARY OF THE INVENTION

IN ACCORDANCE WITH ONE ASPECT OF THE INVENTION, there is provided a dispenser to dispense, in operation, a particulate, soluble chemical agent, by dissolution from a compacted or compressed form thereof, into liquid that flows along a flow path, the dispenser comprising
a body defining a liquid treatment chamber;
an inlet to the liquid treatment chamber, through which inlet feed liquid can, in operation, continuously be fed into the treatment chamber; and
an outlet from the treatment chamber, through which outlet product liquid, containing dissolved chemical agent can, in operation, continuously leave the treatment chamber, the dispenser being configured such that a chemical agent artefact comprising the particulate, soluble chemical agent in a compacted or compressed form is arrangeable in the dispenser, in use, in a predetermined position in which the artefact is exposed to or accessible from inside of the treatment chamber only along a liquid contact surface provided by part of an outer surface thereof, which part extends along an artefact access plane defined in the dispenser in use at the predetermined position, such that liquid which is fed to the treatment chamber through the inlet, in operation, can contact the artefact only along the liquid contact surface and necessarily by passing across the artefact access plane.

In the sense of ‘liquid treatment chamber’ the word ‘treatment’ is used merely to indicate dispensing of the chemical agent into the liquid through dissolution and not necessarily the effect that the chemical agent could have on the liquid once dispensed into the liquid. In other words, ‘treatment’ does not necessarily mean that the particular chemical agent is a treatment for the particular liquid, although in some applications it could be. In other applications, however, the liquid could merely be a medium for transporting the particular chemical agent.

By ‘in use’ is meant a configuration in which the dispenser is employed as a dispenser assembly has hereinafter described, i.e. with the chemical agent artefact arranged in the predetermined position as described. By ‘in operation’ is meant a configuration of the dispenser in use, forming part of a chemical agent dispensing system as hereinafter described and thus being provided in the flow path such that liquid flowing along the flow path, when there is such flow, flows into the treatment chamber through the inlet and leaves the treatment chamber through the outlet. The water treatment chamber would therefore form part of the flow path in operation. If the dispenser is not provided in line with the flow path, it would at least typically be provided so that such continuous flow into and out of the treatment chamber, in operation, occurs. This may be, for example, by means of a venturi-type arrangement as hereinafter described. In such configurations, a water treatment system, as hereinafter described, is essentially provided.

The liquid may, in particular, be water. The dispenser will, accordingly, hereinafter be described with reference to water. However, it is to be appreciated that whilst the dispenser is expected to find particular application in dispensing the chemical agent into water, the liquid could, instead, be a different liquid than water.

The dispenser may be configured such that some of the water that is continuously fed to the treatment chamber, in operation, collects inside the chamber. More particularly, the water treatment chamber, the inlet and the outlet may be configured such that some of the water that continuously enters the chamber, in operation, collects, or accumulates, inside the chamber, e.g. by favouring volumetric inlet over volumetric outlet to such an extent that accumulation, in operation, is achieved. Such configuration may additionally/alternatively be based on back pressure in a flow line defining the flow path, which back pressure may cause the accumulation. The treatment chamber may therefore, in operation, become, and effectively remain, at least partly filled with water. At least some of the water entering the treatment chamber may therefore have a residence time inside the treatment chamber before leaving the treatment chamber through the outlet. The configuration of the dispenser in this regard may, in particular, be such that the extent to which water accumulates inside the treatment chamber, in operation, is such that water contact with the artefact along the liquid, or water, contact surface is virtually constantly maintained in operation. In some cases, the chamber may therefore, at any given time in operation, during steady-state in operation, contain a virtually constant volume of water and/or contain a volume of water which maintains a virtually constant level inside the chamber. By steady-state operation is meant a situation in which the treatment chamber is filled with water to such a maintainable, virtually constant level or contains such a maintainable, virtually constant volume of water, in operation when there is flow along the flow path.

The water contact surface may, in use, be provided by a single face or general side of the artefact, extending along a single plane, being the artefact access plane. By “general side” is meant a side of the artefact that extends, generally, along a single plane, regardless of minor surface irregularities that such a side may have which results in the side not being fully planar. It will be appreciated that whilst such surface irregularities may result in the water contact surface not, strictly speaking, being fully located in or extending strictly along the access plane, it would still, generally speaking, be located in and extend along it. Preferably, however, the water contact surface would be planar and would extend fully along the access plane. In a preferred embodiment of the invention, the artefact has a cylindrical configuration. In such a case, the water contact surface may, in particular, be provided by an axial end surface of the artefact. Preferably, the artefact is circular cylindrical.

Regarding configuration of the dispenser for arrangement of the chemical agent artefact as described: The dispenser may have a chemical agent artefact supporting formation which supports, in use, directly or indirectly, the chemical agent artefact such that the water contact surface is exposed to or accessible from inside of the treatment chamber only along the liquid contact surface. The supporting formation may therefore in some embodiments of the invention, at least in part, describe the water contact surface in use. The supporting formation may define a support plane which may, typically, be parallel to or co-planar, in use, with the access plane. The supporting formation may, in particular, be provided by an artefact housing which encloses the artefact in such a manner that the water contact surface is exposed to or accessible from the treatment chamber as herein described. The housing may be provided at least partly by, i.e. may be integral with, the body of the dispenser. Alternatively, the housing may be a removable, and optionally disposable and replaceable, part of the dispenser.

As indicated, the chemical agent artefact may be an artefact from which the chemical agent can, in operation, be dissolved when the feed liquid contacts the artefact, in operation, with chemical agent thereby being dispensed into the feed liquid through dissolution.

In one embodiment, the chemical agent may comprise a highly soluble chemical, suitable and effective for disinfection in particular, i.e. a disinfectant. Suitable chemicals in this sense may include, in particular, any one or more of sodium chlorate, sodium bisulphate, calcium chloride, sodium dichloro-iso-cyanurate (NaDCC), citric acid (the four preceding components used in combination in some contexts being known in the art of the invention as ‘chlorine dioxide’), sodium bicarbonate, and sodium hydroxide. Preferably, however, the chemical agent is calcium hypochlorite.

In other embodiments of the invention, the chemical agent may also/alternatively comprise a particulate, soluble pH control agent, as hereinafter described, and/or a solid, soluble fertilizer.

The artefact may, in one embodiment of the invention be fully erodible through dissolution, comprising a major proportion of dissolvable material, a major portion of which is made up of the chemical agent. Alternatively, particularly in high pressure applications as hereinafter quantified, the chemical agent artefact may comprise a compacted or compressed body of an admixture of a particulate water insoluble artefact structuring agent providing an artefact matrix and a particulate water-soluble chemical agent embedded in the artefact matrix.

The structuring agent, when employed, may, by mass, comprise a major portion of the artefact. The structuring agent may, in particular, comprise calcium phosphate and/or calcium sulphate.

When a structuring agent is employed, the artefact may also comprise a particulate soluble liberating agent, dissolution of which from the chemical agent artefact increases the porosity of the chemical agent artefact for water to access and dissolve from the artefact the chemical agent. In other words, dissolution of the liberating agent may create additional pathways in the artefact matrix to those created through dissolution of the chemical agent, along which additional pathways water access to chemical agent contained in the artefact matrix is facilitated. Preferably, although not necessarily, the liberating agent is non-reactive with the chemical agent in water. In operation, non-reactive dissolution of the liberating agent may assist particularly in allowing feed water to access and thus liberate chemical agent from the artefact matrix and be treated by the chemical agent by dissolution thereof.

The liberating agent may typically comprise an inert salt and/or a pH control agent. In the sense of the salt, ‘inert’ is to be understood as referring to the salt's non-reactivity with the chemical agent in water. Preferably, the inert salt is sodium chloride, i.e. table salt (NaCl), provided that the sodium chloride comprising the inert water soluble agent is not bound in a calcium hypochlorite complex. When the liberating agent comprises a pH-control agent, the pH control agent may be a chemical or substance that effects, for the purpose of exercising pH control, the pH of water into which it is dispensed. Such a pH-control agent may, in particular, be, as mentioned, citric acid, or it may be sodium bisulphate, for reducing pH, or caustic soda, for increasing pH.

When the chemical agent is calcium hypochlorite, the artefact may comprise, by mass, between about 20% and about 50% of the calcium hypochlorite, both values inclusive. Preferably, the artefact comprises, by mass, between about 25% and about 30% calcium hypochlorite.

When the structuring agent is calcium phosphate, the artefact may comprise, by mass, between about 50% and about 80% of the calcium phosphate, both values inclusive. Preferably, the artefact comprises, by mass, between about 55% and about 65% of the calcium phosphate.

When the artefact comprises the liberating agent and the liberating agent is sodium chloride, the artefact may comprise, by mass, between about 1% and about 10% of the sodium chloride, both values inclusive. Preferably, the artefact comprises, by mass, between about 5% and about 10% of the sodium chloride.

In an embodiment of the invention in which citric acid is used as liberating and/or pH control agent, or for whichever other purpose, the artefact may comprise, by mass, from 15% to 35%, preferably 25%, calcium hypochlorite, from 15% to 35%, preferably 25%, citric acid and from 40% to 60%, preferably 50%, calcium phosphate.

The artefact may also comprise, by mass, from about 1% to about 2% sodium tripolyphosphate (STPP) as wetting agent.

The artefact may, in some embodiments of the invention, be an artefact as described in the specification of WO2007/000747, the full content of which is hereby incorporated into the present specification by way of reference.

In one embodiment of the invention, the dispenser may be configured such that the artefact access plane, in use, extends substantially parallel to or co-linearly with an inlet flow axis along which feed water passes through the inlet into the water treatment chamber. The dispenser may then be configured as hereinbefore described such that the treatment chamber, in operation and particularly steady state operation, substantially fills and remains, during steady state operation, filled with water, at least up to the access plane, with there being virtually constant water contact with the chemical agent artefact along the water contact surface. In such an embodiment, dissolution of chemical agent from the artefact across the access plane, in operation, may be driven by back pressure generated, in operation, in the flow path. The flow path may then, in particular, be a flow path of a high pressure water line. More particularly, the pressure may be at least 4 bar. The pressure may even be up to 7 bar, or even higher, in which case the dispenser may include a bypass as hereinafter described. In other words, in operation, with accumulation of water in the treatment chamber being resulting once steady-state operation is achieved, in an accumulated volume of water inside the treatment chamber contacting the artefact along the water contact surface thereof virtually constantly, dissolution of chemical agent from the artefact across the access plane may be driven by back pressure along the flow path. Preferably, in such an embodiment, the access plane lies across and substantially perpendicular to an upstream projection of an outlet flow axis along which liquid leaves the treatment chamber through the outlet, in operation.

The use of the word ‘driving’, in all its forms, in qualifying ‘dissolution’ in general in this specification, is meant more than merely contacting the chemical agent artefact with water along the water contact surface, but rather driving, or encouraging, water permeation into the chemical agent artefact across the access plane as well as resulting dissolution of the chemical agent from the chemical agent artefact. This may be effected by directing a water pressure force and/or water pressure force component, and/or water flow and/or water flow component toward the water contact surface in operation, whether water accumulation occurs in the treatment chamber or not. It also encompasses effecting virtually constant water movement along the water contact surface in operation so as to avoid overdosing through dissolution in water adjacent the water contact surface and promote dispersal of dispensed chemical agent to water in the water treatment chamber. It will be appreciated that, in the presently discussed embodiment in which the access plane does not lie across the axial flow direction, dissolution is not driven by direct stream impingement on the access plane and/or the water contact surface, considering that such impingement does not take place when the artefact access plane extends substantially parallel to or co-linearly with the inlet flow axis.

In another embodiment of the invention, the dispenser may be configured such that the artefact access plane extends at an angle greater than 0° and smaller than 90°, e.g. 45°, to the inlet flow axis. The configuration of the dispenser may, in particular in such an embodiment, be such that the water contact surface does not, in use, lie across the inlet flow axis, but is spaced therefrom. The dispenser may then also be configured as hereinbefore described such that the treatment chamber, in operation and particularly in steady state operation, fills and remains filled with water at least up to the access plane, with there being virtually constant water contact with the chemical agent artefact along the water contact surface in operation. In such an embodiment, dissolution of chemical agent from the artefact across the access plane may be driven at least in part by diverted inlet flow or by a diverted inlet flow component of the axial inlet flow of feed water entering the treatment chamber in a direction along the inlet flow axis through the inlet, which diverted inlet flow or diverted inlet flow component is diverted from the flow axis and is directed at the access plane. By ‘diverted inlet flow’ is meant the axial inlet flow of feed water, or a component thereof, being diverted from being directed in a direction along the inlet flow axis to being directed in a direction toward the access plane. The treatment chamber in particular may, in such a case, be oriented such that some of the water entering the treatment chamber along the inlet flow axis is directed away from the inlet flow axis, toward the access plane. In other words, the treatment chamber may be configured such that a part of the flow entering the treatment chamber along the inlet flow axis is, in operation, directed toward and substantially straight at the access plane and water contact surface, away from the inlet flow axis. More particularly, the treatment chamber may have a wall that is configured to direct or divert, in operation, at least a part of the flow of feed water entering the treatment chamber along the inlet flow axis, away from the inlet flow axis, substantially straight toward the access plane and water contact surface. Although not wishing to be bound by theory, the applicant has found that by diverting the inlet or part thereof as described, dissolution of treatment agent from the treatment agent artefact is not only driven by the diverted flow, but mixing of water in the treatment chamber is also achieved through turbulence generated adjacent the water contact surface. This has been found to avoid the formation of a high chemical agent concentration, or overdose, zone adjacent the water contact surface, which is undesired where even dispensing of chemical agent is required and also insofar maintaining dissolution of treatment agent is concerned.

In yet another embodiment of the invention, the artefact access plane may extend substantially perpendicularly, i.e. at about 90°, to the inlet flow axis. In one form of this embodiment, the artefact access plane and the water contact surface may face in a downstream direction with respect to the flow direction along the inlet flow axis into the treatment chamber, with a facing direction of the access plane being into a direction from which water access across it generally occurs, in operation. Dissolution of chemical agent from the artefact across the access plane may then be driven by turbulence resulting on an outlet or downstream side of the access plane. More particularly, the dispenser may be configured such that the artefact is, in use, arrangeable in the treatment chamber in a downstream-open housing, such that liquid entering the treatment chamber through the inlet, in operation, impinges on a closed upstream end of the housing and passes along sides of the housing toward the outlet, thereby resulting in turbulent flow occurring adjacent a downstream side of the access plane, which turbulent flow, at least in part, drives dissolution of the chemical agent from the artefact in an upstream direction. In another form of this embodiment, the access plane, and the water contact surface, may face in an upstream direction with respect to flow direction. Preferably, in the embodiments described in this paragraph, the artefact access plane, and the water contact surface, lies across a downstream projection of the inlet flow axis. When the access plane faces in the upstream direction, dissolution of chemical agent from the artefact across the access plane may be driven by axial inlet flow of feed water along the inlet flow axis, being directed straight onto the water contact surface. It will be appreciated that, in such an embodiment, virtually the full axial inlet flow of feed water that enters the treatment chamber through the inlet is directed directly onto the access plane and thus onto the water contact surface. In such an embodiment, water accumulation inside the treatment chamber would typically not be necessary since artefact erosion and treatment agent dissolution occurs and is driven by direct stream impingement.

The artefact may be partly covered by an artefact cover. The cover may be water impervious, exposing only the water contact surface. The cover may, in one embodiment of the invention, be a housing provided by the body or by another part of the dispenser, e.g. a holder that is mountable thereto. In such a case, the housing may provide the supporting formation. In another embodiment of the invention, the cover may be a covering layer which is directly applied to, and therefore carried by, the artefact. The cover may be employed in conjunction with the housing. When the housing is employed, it may, in use, be substantially fully occupied by the artefact or by the artefact in conjunction with a water pervious member as hereinafter described.

The dispenser may include, in use, a water pervious member that is located adjacent the water contact surface such that water contact with the water contact surface occurs, in use, through the water pervious member. The water pervious member may extend across the whole of the water contact surface such that water contact with the water contact surface, in operation, occurs only though the water pervious member. The water pervious member may have an artefact abutment surface that is complemental to the water contact surface of the artefact, thus extending, in use, across a surface area that is at least substantially equal to the surface area across which the water contact surface extends. The water pervious member may then, in use, be in abutment, along its artefact abutment surface, with the artefact along substantially the whole of the water contact surface of the artefact. It will be appreciated that, in such a configuration, the water contact surface of the artefact is, in use, thus rendered accessible to the untreated, or treated, water only through the water pervious member.

Preferably, the water pervious member has a pore size of between about 0.15 mm and about 1.5 mm, both values inclusive, typically having a thickness of between about 2 mm and about 10 mm, both values inclusive. The water pervious member may be of plastic or silicone, e.g. silicone foam, or of a ceramic material. The pores of the water pervious member may, naturally, extend across the width of the pervious member. In a preferred embodiment in which the water pervious member has a cylindrical configuration, the pores would, of course, extend between and open out into axial end surfaces of the water pervious member.

The inlet and outlet may, respectively, be provided by inlet and outlet conduits defined by inlet and outlet formations of the body.

THE INVENTION EXTENDS TO a dispenser kit to dispense, by dissolution, a particulate, soluble chemical agent from a compacted or compressed form thereof into a liquid flowing along a flow path, the kit comprising
a dispenser as hereinbefore described; and
a chemical agent artefact as hereinbefore described.

THE INVENTION ALSO EXTENDS TO a dispenser assembly comprising
a dispenser as hereinbefore described; and
a chemical agent artefact as hereinbefore described arranged in the dispenser in the manner in which it is hereinbefore described as being arrangeable in the dispenser.

The assembly may, in particular, comprise the dispenser as hereinbefore described, in use.

THE INVENTION ALSO EXTENDS, SEVERALLY, TO the dispenser as hereinbefore described in use and in operation.

IN ACCORDANCE WITH ANOTHER ASPECT OF THE INVENTION, there is provided a chemical agent dispensing system to dispense, in operation, particulate, soluble chemical agent into liquid that flows along a flow path, the system including
flow path defining means providing a flow line and defining the flow path, a flow path inlet to and a flow path outlet from the flow path; and
a dispenser as hereinbefore described, the dispenser being arranged in the flow path between the flow path inlet and the flow path outlet, such that, in operation, feed liquid flowing along the flow path continuously feeds into the treatment chamber of the dispenser along the inlet thereto, with at least some of the feed liquid contacting a chemical agent artefact arranged in the dispenser, in use, across the access plane along the liquid contact surface thereof, thereby to dissolve chemical agent from the artefact into the feed liquid to obtain product liquid which is continuously withdrawn from the treatment chamber along the outlet therefrom.

Use and operation of the dispenser in the system may be as hereinbefore described with reference to the dispenser according to the invention, in use and in operation.

In one embodiment of the invention, the flow line may be a high pressure line. The dispenser may then be configured as hereinbefore described such that some of the feed water that continuously enters the chamber, in operation, collects, or accumulates, inside the chamber, in the manner hereinbefore described. In such an embodiment, the artefact access plane may extend substantially parallel to or co-linearly with an inlet flow axis along which feed water passes through the inlet into the water treatment chamber. Dissolution of chemical agent from the artefact across the access plane may, in operation, then be driven by back pressure in the line. The pressure in the line may be above 4 bar, even up to 7 bar or higher.

Alternatively, typically in lower pressure applications, the access plane may be at an angle of greater than 0° and smaller than 90° to the inlet flow axis. The dispenser may then also be configured as hereinbefore described such that some of the feed water that continuously enters the chamber, in operation, collects, or accumulates, inside the chamber, in the manner hereinbefore described. In such an embodiment, dissolution of chemical agent from the artefact may be driven, in operation, by diverted inlet flow of feed water, or a component thereof, originating from an axial inlet flow of feed water entering the treatment chamber along the inlet thereto and being directed toward the water contact surface.

Still further, alternatively, the access plane may be substantially perpendicular to the flow axis, facing in an upstream direction with direct impingement of inlet flow through the inlet into the treatment chamber onto the access plane and water contact surface, in operation, driving dissolution of chemical agent from the artefact across the access plane.

Yet further, alternatively, also with the access plane substantially perpendicular to the flow axis and facing in downstream direction, turbulent flow, as hereinbefore described, adjacent a downstream side of the access plane may, at least in part, drive dissolution of the chemical agent from the artefact.

Arrangement of the dispenser may be directly in line with the flow path, i.e. with water flowing along the flow path in operation feeding directly into the treatment chamber. Alternatively, the dispenser may be provided in the system in a venturi-effect type arrangement, i.e. with feed water being drawn from the flow path in accordance with the venturi-effect.

The system may include a bypass along which water can, in operation, be withdrawn from the flow path upstream of the dispenser, or at least upstream of the treatment chamber thereof, and be introduced back into the flow path downstream of the dispenser/treatment chamber thereof. It must be appreciated that it is therefore expected that the dispenser may incorporate such a bypass, e.g. by including a bypass conduit. This feature is optional to the dispenser as described above. It must be appreciated that, in accordance with this possibility, it is possible that the dispenser may be provided on a branch line of a main flow line, in which case the flow path would be a branch flow path. The bypass would typically be employed in applications where the pressure is higher than 4 bar and a pressure drop needs to be established over the dispenser in order to reduce the pressure on the artefact, in use.

The ratio of the volumetric flow rate of water that bypasses the dispenser/treatment chamber to the volumetric flow rate of water that is fed into the dispenser/treatment chamber may be determined by the chemical agent dosing that is required from the dispenser. Typically, the arrangement is configured for the ratio of the volumetric flow rate of water that bypasses the dispenser/treatment chamber to the volumetric flow rate of feed water that is fed into the dispenser/treatment chamber to be in favour of the volumetric flow rate of water that bypasses the dispenser/treatment chamber, with feed water thus being introduced into the dispenser/treatment chamber at a lower volumetric flow rate than the volumetric flow rate of water that bypasses the dispenser/treatment chamber. It will be appreciated that combining product water from the dispenser/treatment chamber with feed water bypassing the dispenser/treatment chamber, results in feed water that bypassed the dispenser/treatment chamber becoming treated with the chemical agent contained in the product water. The ratio of the volumetric split between the main stream and the bypass stream may be determined on the basis of the desired concentration of chemical agent that is to be dispensed into the main stream, once recombined with the bypass stream, and also keeping in mind the constitution, i.e. chemical agent concentration, of the chemical agent artefact from which the chemical agent is obtained.

The system may include, downstream from the dispenser, a filter. The filter may, in particular, be a membrane filter or a ceramic filter. By including such a filter, either as integrated part of the body of the dispensing dispenser utilising a disposable filter medium component, or as a separate component, it is envisaged that the delivery of a product water stream of enhanced purity, free from any unwanted microscopic particulate matter, is enabled. This is expected to make the dispenser suitable for use in highly technical applications requiring accurate calcium hypochlorite dispensing and substantially completely disinfected water. One such application is wound irrigation during surgery.

The system may further include, either as part of an integrated system or downstream from the dispenser in a separate dispenser, an acidifier dispensing a dry acidification chemical based on the same principles set out in this invention. The incorporation of this additional feature will serve, in use, to reduce the pH and thus acidify the product water. The acidifier may, in particular, be configured to deliver an acidifying agent to the product water. Alternately a dry but soluble chemical acid may be added to the formulation and compressed with the standard blend in order to reduce the pH of the product water.

IN ACCORDANCE WITH A FURTHER ASPECT OF THE INVENTION there is provided a method of dispensing a particulate soluble chemical agent by dissolution from a compacted or compressed form thereof into liquid flowing along a flow path, the method including
feeding feed liquid along a flow path into a liquid treatment chamber which has an inlet, an outlet, and a chemical agent artefact comprising particulate, soluble chemical agent in a compacted or compressed form, such that at least some of the feed liquid contacts the artefact from inside the treatment chamber along a water contact surface thereof which is exposed to or accessible from inside of the treatment chamber and is provided by a part of an outer surface of the artefact that extends along and is necessarily accessible across an artefact access plane, with at least some of the feed liquid passing across the access plane and dissolving chemical agent from the artefact, thereby dispensing chemical agent from the artefact by dissolution into the feed liquid and obtaining product liquid; and
allowing product liquid comprising dissolved chemical agent to leave the treatment chamber through the outlet.

The liquid may be as hereinbefore described.

The treatment chamber may be a treatment chamber of a dispenser also as hereinbefore described.

Further, the chemical agent artefact may also be as hereinbefore described, as may the water contact surface and the artefact access plane. The manner in which dissolution of the chemical agent across the access plane is driven may also be as hereinbefore described.

More particularly, in one embodiment of the method, the flow path may be defined by a high pressure line, in which case the method may include feeding feed liquid into the treatment chamber in a direction along an inlet flow axis parallel to or co-linear with the access plane and allowing at least some feed liquid to accumulate inside the treatment chamber such that, whilst there is flow along the flow path, water contact with the chemical agent artefact along the water contact surface is virtually constantly maintained. The method may then include driving dissolution of chemical agent from the chemical agent artefact across the access plane and the water contact surface by means of back pressure in a the high pressure line.

Alternatively, feed liquid may be fed into the treatment chamber in a direction along an inlet flow axis at greater than 0° and smaller than 90° to the access plane with at least some feed liquid being allowed to accumulate inside the treatment chamber such that, whilst there is flow along the flow path, water contact with the chemical agent artefact along the water contact surface is virtually constantly maintained. The method may then include driving dissolution of chemical agent from the chemical agent artefact across the access plane and the water contact surface by diverting inlet flow of feed water, or component thereof, from axial inlet flow of liquid into the treatment chamber through the inlet along the inlet flow axis toward the access plane and the water contact surface.

As another alternative, the method may include feeding feed liquid into the treatment chamber in a direction along an inlet flow axis that is substantially perpendicular to the access plane and driving dissolution of chemical agent from the chemical agent artefact across the access plane and the water contact surface by means of direct flow impingement of feed water along the inlet flow axis onto the water contact surface.

As yet a further alternative, the method may include feeding feed liquid into the treatment chamber in a direction along an inlet flow axis that is substantially perpendicular to the access plane, with the access plane facing in a downstream direction relative to the direction of flow.

In such a case, the method may include and driving dissolution of chemical agent from the chemical agent artefact across the access plane and the water contact surface by means of upstream turbulence adjacent a downstream side of the access plane and water contact surface.

IN ACCORDANCE WITH YET ANOTHER ASPECT OF THE INVENTION, there is provided a chemical agent artefact which comprises a compacted or compressed body of an admixture of
a particulate insoluble artefact structuring agent providing an artefact matrix; and
a particulate soluble chemical agent embedded in the artefact matrix.

The solubility and insolubility may, in particular, be with respect to water.

The chemical agent artefact, structuring agent and chemical agent may be as hereinbefore described. The artefact may therefore comprise a liberating agent as hereinbefore described.

The chemical agent artefact may have a water contact surface defined by a water impermeable cover or housing, as hereinbefore described.

### BRIEF DESCRIPTION OF THE DRAWINGS

The invention will now be described in more detail with reference to the accompanying diagrammatic drawings, in which

FIG. 1 shows, in three-dimensional view, one embodiment of a dispenser in accordance with the invention;

FIG. 2 shows, in three-dimensional sectional view along plane A′-A′, the dispenser of FIG. 1 from a different angle;

FIG. 3 shows, in mirrored sectional view relative to FIG. 2, the dispenser of FIG. 1;

FIG. 4 shows, in three-dimensional sectional view, the dispenser of FIG. 1 in an open configuration;

FIG. 5 shows, in mirrored sectional view relative to FIG. 2, the dispenser of FIG. 1 as part of one embodiment of a dispenser assembly in accordance with the invention;

FIG. 6 shows, in mirrored sectional view relative to FIG. 2, the dispenser of FIG. 1 as part of another embodiment of a dispenser assembly in accordance with the invention;

FIG. 7 shows, in partially open side view, another embodiment of a housing of the dispenser assembly of FIG. 6;

FIG. 8 shows, in three-dimensional bottom view, the housing of FIG. 7;

FIG. 9 shows, conceptually, a flow diagram of one embodiment of a water treatment system in accordance with the invention;

FIG. 10 shows, in three-dimensional view, another embodiment of a dispenser in accordance with the invention;

FIG. 11 shows, in sectional side view, one form of the dispenser of FIG. 10, the dispenser being shown as part of another embodiment of a dispenser assembly;

FIG. 12 shows, in sectional side view, another form of the dispenser of FIG. 10, the dispenser being shown as part of yet another embodiment of a dispenser assembly;

FIG. 13 shows, in exploded sectional side view, yet another embodiment of a dispenser in accordance with the invention, the dispenser being shown as part of a further embodiment of a dispenser assembly; and

FIG. 14 shows, in assembled sectional view, the dispenser of FIG. 13, the dispenser being shown as part of another embodiment of a dispenser assembly.

### DETAILED DESCRIPTION OF THE INVENTION

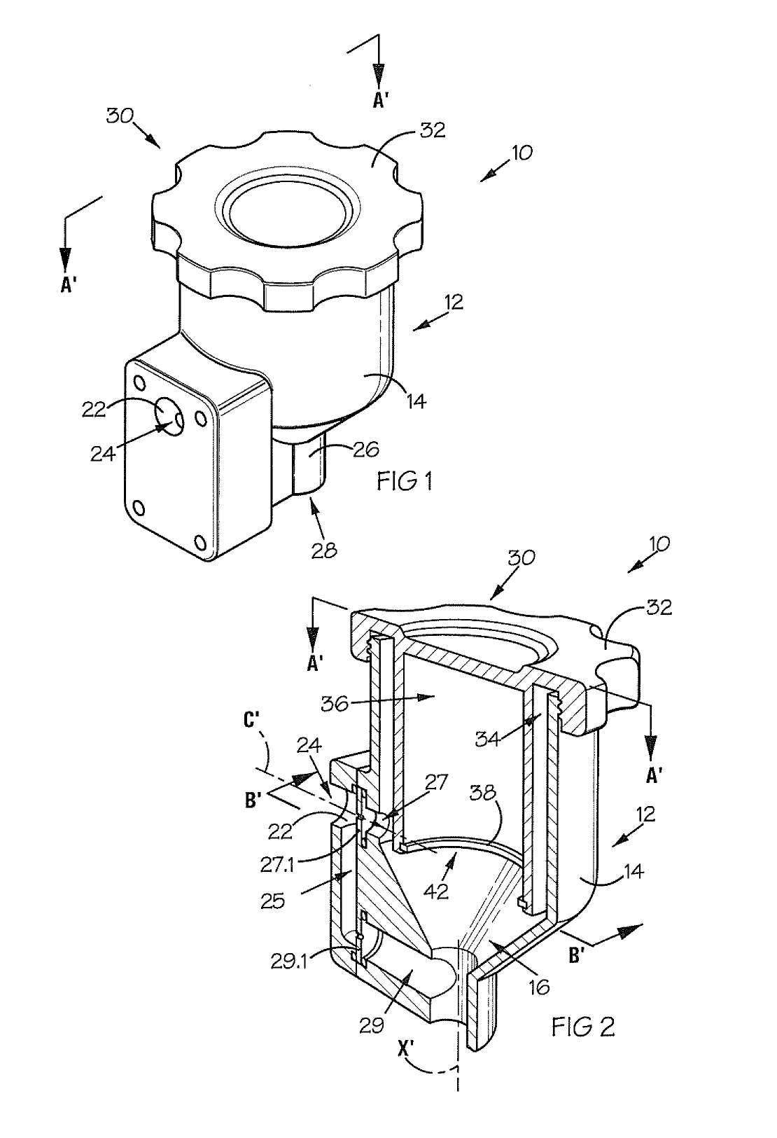

### The Dispenser of FIGS. 1 Through 4

Referring to the drawings and in particular to FIG. 1, reference numeral 10 generally indicates one embodiment of a dispenser in accordance with the invention.

The dispenser 10 is, in particular but not limited to, for dispensing, by dissolution, a particulate, soluble chemical agent, such as calcium hypochlorite in particular, from a compacted or compressed form thereof to a liquid, and particularly water, flowing along a flow path. The chemical agent may, in particular, be contained in a chemical agent artefact as hereinbefore described in accordance with the chemical agent artefact according to the invention, i.e. comprising a compacted or compressed body of a particulate form of the chemical agent dispersed in a water insoluble structuring agent matrix.

The flow path may, for the dispenser 10, particularly be a flow path of a high pressure line. High pressure is regarded as being about 4 bar or higher, even as high as 7 bar, or even higher.

The dispenser 10 has a body 12 having a hollow portion 14.

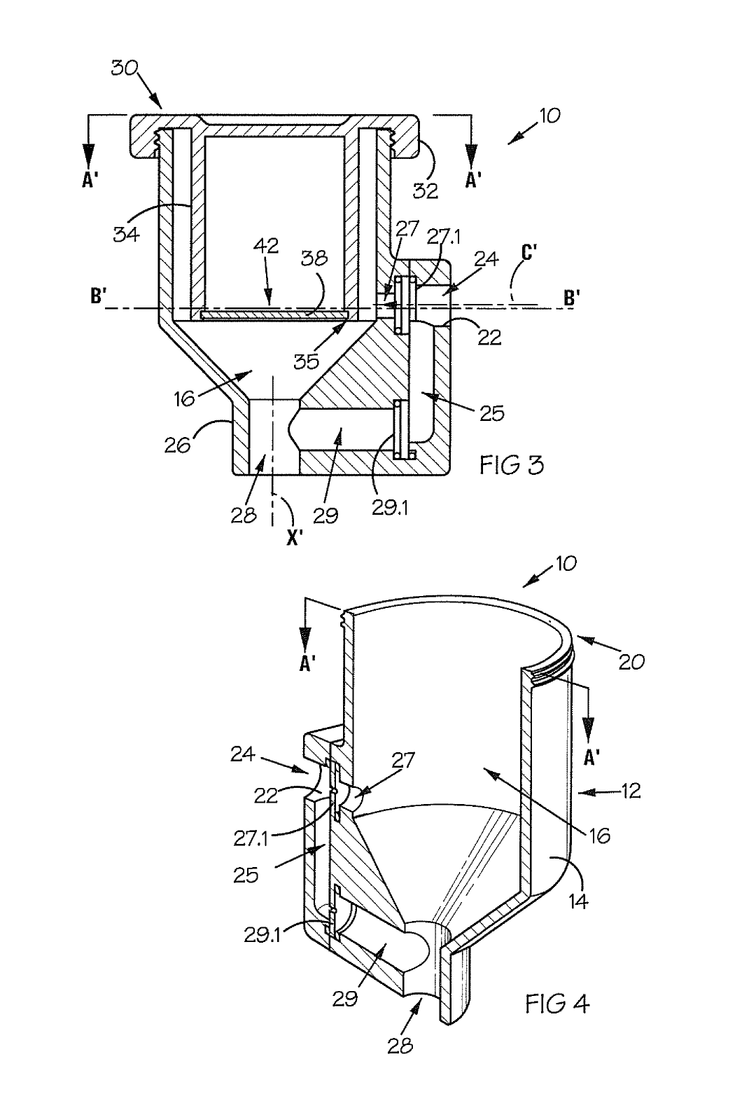

The hollow portion 14 defines a water treatment chamber 16. The treatment chamber 16 comprises a circular cylindrical upper region and an inverted frustoconical lower region, which are more clearly visible in FIG. 4.

The body 12 further has an outlet formation 26 which defines an outlet conduit 28 from the treatment chamber 16. The outlet conduit 28 defines an outlet flow axis X′. The outlet conduit 28 leads from an operative bottom of the treatment chamber 16, said bottom being provided by a truncated narrower end of the treatment chamber 16.

The body 12 further has an inlet formation 22 which defines an inlet conduit 24. The inlet conduit 24 leads to a treatment chamber feed conduit 27, which leads into the treatment chamber 16. The inlet conduit 24 and feed conduit 27 define an inlet flow axis C′ which is perpendicular with respect to the outlet flow axis X′.

The inlet conduit 24 also leads to an optional treatment chamber bypass conduit 29, which leads directly into the outlet conduit 28. Communication between the inlet conduit 24 and the bypass conduit 29 is along a transfer conduit 25. Flow from the inlet conduit 24 respectively to the feed conduit 27 and to the bypass conduit 29 occurs through respective treatment chamber and bypass orifice plates 27.1, 29.1 which are mounted transversely in their respective conduits 27, 29, each plate 27.1, 29.1 having a centrally disposed orifice through which water flows into the respective conduits 27, 29. The orifice of the plate 29.1 is larger than the orifice of the plate 27.1. In operation, feed liquid, particularly water, flowing into the inlet conduit 24 is split between the inlet feed conduit 27 and the transfer conduit 25, leading to the bypass conduit 29. Typically, a greater volumetric flow is delivered to the bypass conduit 29 than to the feed conduit 27. It will be appreciated that, in this manner, a pressure drop is created, in operation, across the treatment chamber 16. The volumetric flow delivered to the bypass conduit 29 could, however, alternatively be smaller than the volumetric flow that is delivered to the feed conduit 27. As will be appreciated, if the bypass conduit 29 is omitted, so would the transfer conduit 25, in which case all of the liquid flowing along the flow path will be fed into the treatment chamber 16. The bypass arrangement would typically be used in very high pressure applications in order to protect the treatment agent artefact from overly aggressive erosion, in use.

The inlet formation 22, the inlet conduit 24, the feed conduit 27, the optional transfer conduit 25, the optional bypass conduit 29, the outlet formation 26 and the outlet conduit 28, as well as the orifice plates 27.1, 29.1, provide an inlet/outlet arrangement of the dispenser 10 along with the treatment chamber 16. The configuration of this arrangement is in favour of inlet volumetric flow such that some water entering the treatment chamber 16 accumulates, in operation, inside the treatment chamber. Although not wishing to be limited by theory, the applicant understands that, in a high pressure line, the back pressure would also assist in necessitating accumulation of water inside the treatment chamber 16. The configuration of the dispenser 10 is, in particular, such that water contact with the chemical agent artefact along its water contact surface is virtually constantly maintained in operation.

As alluded to above, the liquid may, in particular, be water. Accordingly, the dispenser 10 will be described with reference to water as being the liquid that is to be treated. It must, however, be appreciated that substantially the same principles could be applied in relation to other liquids in respect of which the dispensing functionality of the dispenser 10 according to the invention is required.

The dispenser 10 has a chemical agent artefact holder 30 which, in use, holds a chemical agent artefact in accordance with the invention, thereby to provide a dispenser assembly as hereinafter described. In high pressure applications, the artefact would be an artefact as is herein before described.

The holder 30 has a lid 32 having securing formations in the form of screw thread which is engageable with complemental securing formations in the form of complemental screw thread provided on an open top 20 of the body 12. The lid 30 is therefore also a lid of the body 12 of the dispenser 10.

The holder 30 further has a chemical agent artefact housing 34 which extends operatively downwardly from an operatively lower surface of the lid 32. The housing 34 is circular cylindrical. The housing 34 is therefore a removable part of the dispenser 10.

When the securing formations of the lid 32 engage the complemental securing formations of the open top 20 of the body 12, with the top 20 thus being closed by the lid 32, the housing 34 extends downwardly into and is thus located in the water treatment chamber 16 of the body 12, more particularly in the cylindrical portion thereof. A radial clearance region is defined between the housing 34 and walls of the cylindrical region of the water treatment chamber 16.

The housing 34 is hollow to contain the chemical agent artefact, in use, in a predetermined position as hereinafter described. The inner profile of the housing 34 is, in cross section at least, complemental to the cross section of a chemical agent artefact that would, in use, be contained in it, such that the artefact is, cross-sectionally, snugly receivable in the housing 34. In the present case, the housing 34 has a circular cylindrical inner profile in order to accommodate a circular cylindrical artefact.

The housing 34 is open at an operative bottom 42 thereof, thus defining an opening. The opening is indicated by reference numeral 42.

A support disc 38 is provided inside the housing 34, extending into a circumferentially extending supporting groove 35 in the housing 34 adjacent the opening 42. The supporting groove 35 and/or the disc 38 provide/s a supporting formation on which a chemical agent artefact can, in use, be supported in accordance with the invention. The support disc 38 therefore serves to support, in use, directly or indirectly, a chemical agent artefact inside the housing 34. The support disc 38 also serves to limit water access to such an artefact to a water contact surface thereof, which is left exposed by the disc 38. In the illustrated embodiment, the support disc 38 is annular, thus having a centrally disposed aperture in it which effects such exposure and through which such access is allowed. It will be appreciated that the support disc 38, with the aid of the supporting groove 35 which supports it, therefore serves also to define a water contact surface on a chemical agent artefact supported, in use, by means of the support disc 38.

The support disc 38, as supporting formation, defines, along an operatively upper surface thereof, a support plane B′-B′. It will be appreciated that when a face of a chemical agent artefact, in use, rests on and is thus supported by the support disc 38, such a face of the chemical agent artefact will extend along the plane B′-B′ and will be accessible through the opening 42 across the plane B′-B′. The plane B′-B′ therefore also provides a chemical agent artefact access plane. The plane B′-B′ is perpendicular to the outlet flow axis.

In embodiments discussed hereinafter, the artefact access plane is continuously referenced by way of designation B′-B′. The same applies for the inlet flow axis C′ and the outlet flow axis X′. In the present invention, generally, the artefact access plane would, in most instances, also be a support plane in which the chemical agent artefact is supported, in use, on a face thereof. The support plane would, however, not necessarily be the abovementioned support plane defined by the supporting formation and could, in use, be spaced from this support plane.

It will also be appreciated that, as indicated above, the face, or portion thereof that is exposed through the opening in the disc 38, constitutes a water contact surface of such a chemical agent artefact. Of course, in accordance with the invention, the water contact surface can, additionally or instead, be defined by a covering layer that is directly applied to the chemical agent artefact.

Importantly, the access plane B′-B′ extends, in the illustrated embodiment, substantially parallel to the inlet flow axis C′ along which feed water, in operation, passes through the feed conduit 27 into the water treatment chamber 16. In operation, feed water which is fed along the feed conduit 27 into the treatment chamber 16, typically under high pressure hereinbefore quantified, therefore does not, and cannot, directly, whether perpendicularly or at an angle, impinge on the plane B′-B′, and thus also not on the water contact surface of a chemical agent artefact provided inside the housing 34. In the illustrated embodiment, water can only cross the plane B′-B′ and contact such a chemical agent artefact inside the housing 34 by accumulating, or collecting, in the treatment chamber 16 and rising in the treatment chamber 16 along a projection of the outlet axis X′, toward to meet and/or pass the plane B′-B′. In a high pressure line, when the dispenser 10 is, in use, provided in such a line, the back pressure in the line in operation is expected to contribute to causing such water accumulation inside the treatment chamber 16, typically in conjunction with a particular inlet/outlet configuration favouring inlet volumetric flow.

The applicant has found that, in high pressure lines in particular, the back pressure, possibly in conjunction with feed force of water continuously entering the treatment chamber 16, continuously, in operation, provides a dissolution driving force for a volume of water accumulated in the treatment chamber 16 to cross the plane B′-B′ into the housing 34. When the chemical agent artefact is then, in operation, contained in the housing 34, continuously driven contact with it is achieved, thus also causing continuous dispensing of chemical agent by dissolution. In fact, the applicant has found that by maintaining such back pressure-driven force across the plane B′-B′ in operation of the dispenser 10, dissolved chemical agent tends to flow freely across the plane B′-B′ into the treatment chamber 16, notwithstanding maintaining the back-pressure driven dissolution driving force. Although not wishing to be bound by theory, it is understood by the applicant that, in the illustrated embodiment, the back pressure would act substantially perpendicularly on the pane B′-B′, possibly due to the configuration of the outlet conduit.

In operation, at start-up, the treatment chamber 16 will be empty. As feed water enters it along the feed conduit 27, and as a result of the configuration of the inlet/outlet arrangement and, it is understood, also the back pressure in a flow line in which the dispenser 10 is provided when such a flow line is a high pressure flow line, water starts to accumulate inside the chamber 16 until steady-state is achieved, e.g. when open volume in the treatment chamber 16 is fully occupied by water whilst there is continuous flow through the chamber 16, or at least when the chamber contains, at steady state, a maintainable volume of water. Back pressure in the flow line transferred to the volume of water accumulated inside the chamber 16 in an upstream direction through the outlet conduit 28, then drives dissolution of chemical agent, from a chemical agent artefact that is, in operation, provided inside the housing 34, across the access plane B′-B′.

The approach of contacting a chemical agent artefact along a restricted water contact surface thereof and driving dissolution of the chemical agent, in operation, from the artefact by means of the back pressure and not by means of direct impingement of feed passing through the feed conduit 27 onto the chemical agent artefact, has surprisingly been found by the applicant to achieve gradual, even and effective dissolution of chemical agent from a chemical agent artefact as hereinbefore described in accordance with the invention. The approach has been found also to avoid profile leaching as herein described. It has also been found to be advantageous for the access plane B′-B′ to be substantially perpendicular to an axis of flow through the outlet conduit, as is the case in the illustrated embodiment, considering that the back pressure generated from downstream of the conduit 10, in operation, then acts perpendicularly and evenly across the access plane B′-B′ and therefore also on the water contact surface of a chemical agent artefact contained in the housing 34.

### The Dispenser of FIGS. 1 Through 4 as Part of a Dispenser Assembly

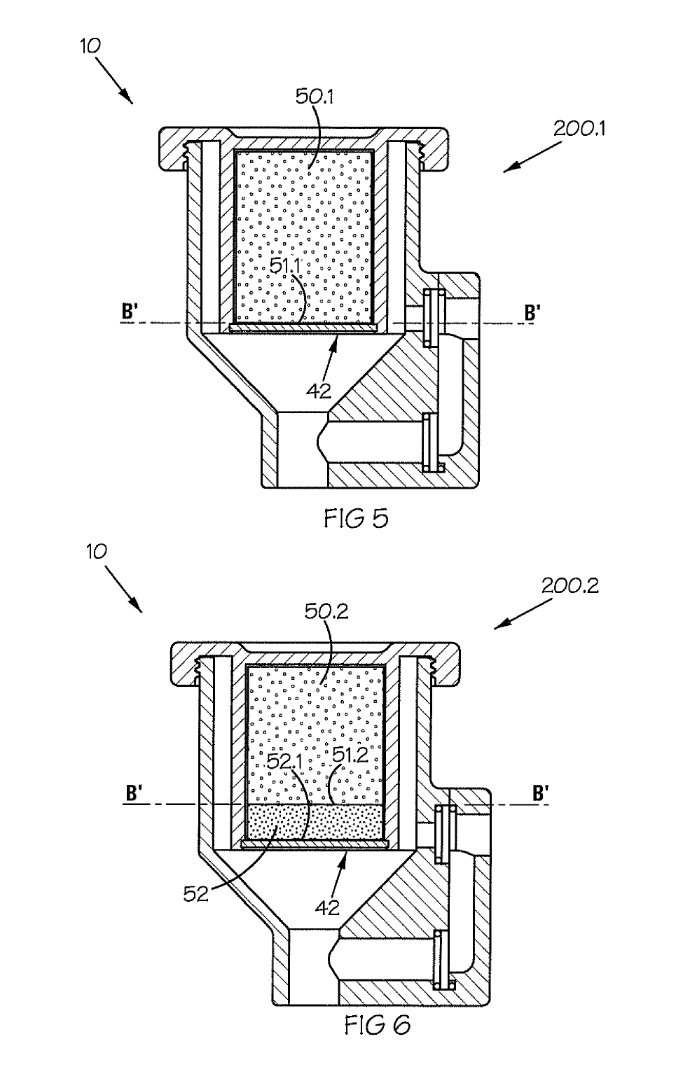

Typical configurations of the dispenser 10 including a chemical agent artefact 50, which could be an artefact in accordance with the invention or, less preferably, one comprising chemical agent only, and, optionally, a water pervious member 52 to provide dispenser assemblies 200.1 and 200.2 in accordance with the invention, are shown in FIGS. 5 and 6. The chemical agent artefact 50 and the water pervious member 52 are circular cylindrical with planar axial end surfaces.

In the assembly 200.1, only a chemical agent artefact 50.1 is provided in the housing 34. It fits, cross sectionally, snugly in the housing 35 and virtually fully occupies the interior thereof. The artefact 50.1 is supported, on an axial end surface thereof, on the disc 38 and thus along the access plane B′-B′. Part of the axial end surface is accessible through the opening 42 and through the opening in the disc 38 to water accumulating in the treatment chamber 16. The exposure of the axial end surface to the water treatment chamber is limited to a water contact surface 51.1 by the disc 38. As has been indicated above, alternatively, or additionally, the water contact surface 51.1 can be defined by a water impermeable cover, or covering layer, applied directly to the artefact.

In the assembly 200.2, another chemical agent artefact 50.2, shorter than the artefact 50.1 of the assembly 200.1, is provided in the housing along with the water pervious member 52, which is interposed between the disc 38 and the artefact 50.2. The water pervious member 52 is therefore supported on the disc 38 with the chemical agent artefact 50.2 being supported on an operatively upper axial end surface of the pervious member 52. Both the chemical agent artefact 50.2 and the pervious member 52 are, cross sectionally, snugly received in the housing 34, together virtually filling the housing 34. The water pervious member has a pore size of between about 0.15 mm and about 1.5 mm, both values inclusive, typically having a thickness of between about 2 mm and about 10 mm, both values inclusive.

Since the support plane of the chemical agent artefact 50.2 has been moved by the inclusion of the previous member 52 in this embodiment, so has the access plane B′-B′ which is now operatively above pervious member 52 along the water contact surface 51.2.

Water access to the artefact 50.2 is therefore possible only though the water pervious member 52, across an exposed surface 52.1 thereof through the opening 42. Although sides of the housing 34 limit water contact with the artefact to the axial end surface thereof which provides the water contact surface 51.2, it is envisaged that it would be preferred for the artefact 50.2 to have a water impermeable cover applied thereto, which cover defines the water treatment surface. This would apply to the presently discussed embodiment in particular, but also to the invention generally where there is doubt as to the integrity of the limited availability of the water contact surface.

The applicant has found that employment of the water pervious member prevents profile leaching of chemical agent from the chemical agent artefact from occurring, which profile leaching usually results in chemical agent being leached from the artefact along a single leaching profile. Chemical agent content of the artefact that is not accessible along such a profile is thus not leached from the artefact, with the chemical agent content of the artefact therefore not being fully exploited. Without wishing to be limited by theory, it is understood that the effect of the water pervious member in this regard is that it directs that water contact with the chemical agent artefact occurs substantially normally to and evenly across the water contact surface thereof, with chemical agent thus being progressively and evenly leached from the artefact along an axially moving erosion plane that is essentially parallel to the artefact access plane.

### Alternative Embodiment of the Holder 32 of the Dispenser 10

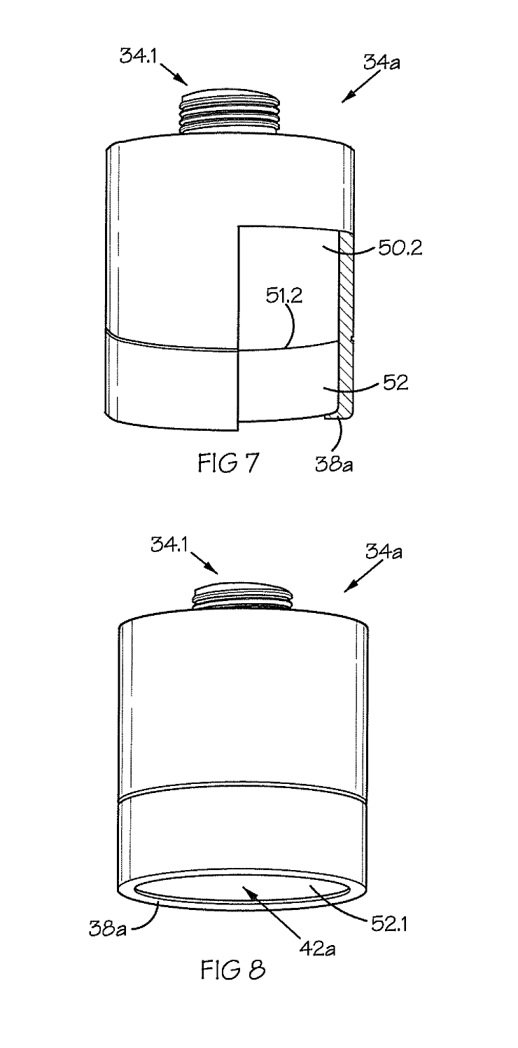

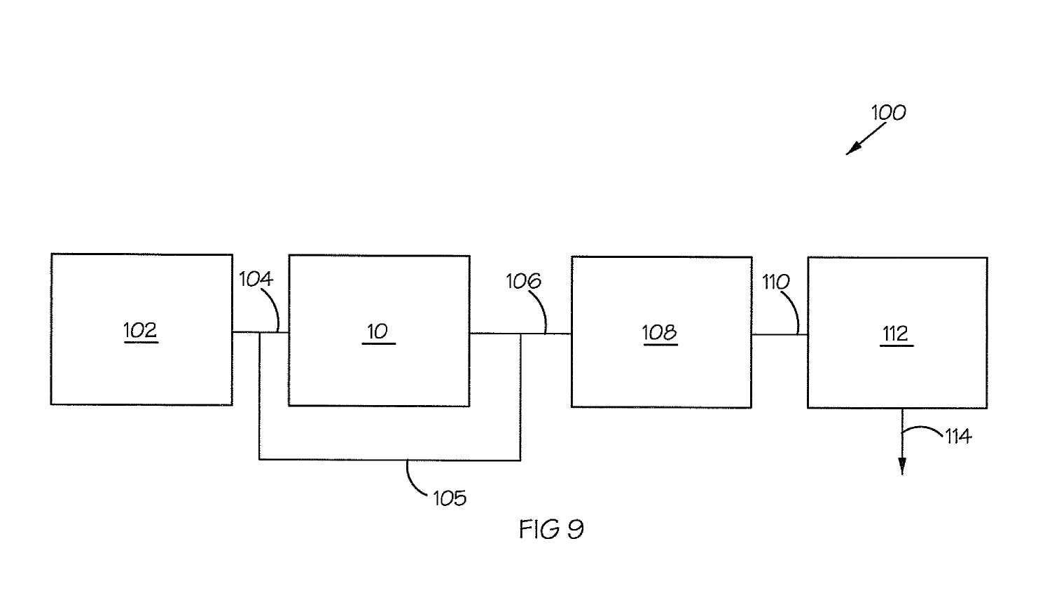

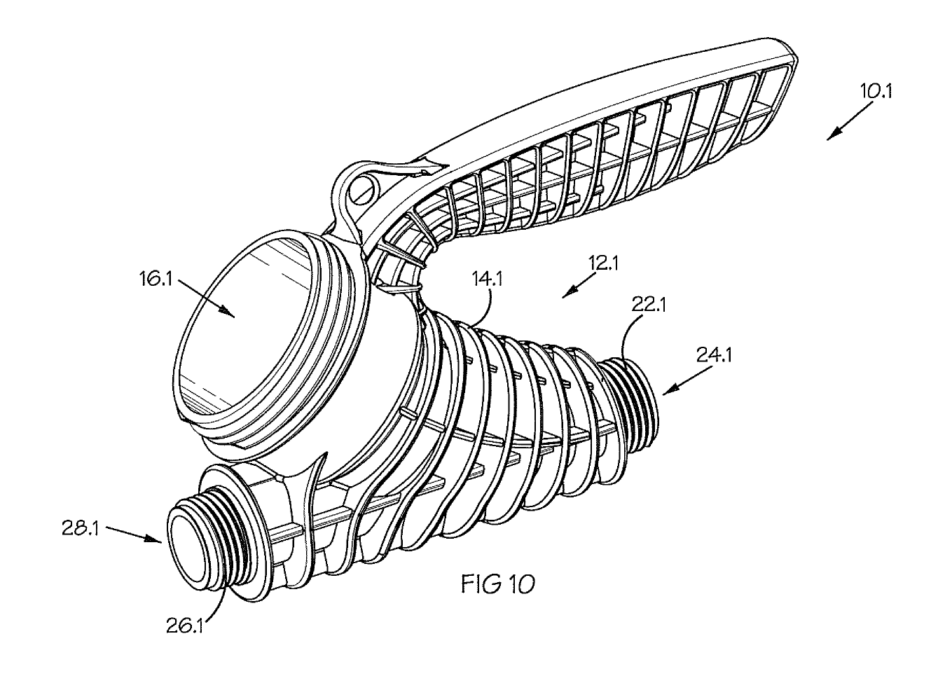

In an alternative embodiment of the dispenser 10, the housing 34 may be removable from the lid 32. Referring in this regard particularly to FIGS. 7 and 8 and using the same base reference numerals used in FIGS. 1 to 6: In such an embodiment of the holder 32 the corresponding embodiment of a housing 34a has a screw threaded attachment member 34.1 projecting operatively upwardly from a closed upper end 34b thereof. The attachment member 34.1 is threadingly engageable with a complementally threaded cavity defined in the lid 32. This is, however, not illustrated in the drawings.

The embodiment of the housing 34a illustrated in FIGS. 7 and 8 is shown with the same arrangement of the artefact 50.2 and pervious member 52 that is shown in FIG. 6. Of course, it could, alternatively, comprise only the artefact 50 in the manner shown and described in relation to FIG. 5.

### Water Treatment System of FIG. 9

Referring now to FIG. 9, reference numeral 100 generally indicates one embodiment of a water treatment system according to the invention.

The system 100 includes an feed water source 102 from which leads an feed water line 104 along which a stream of feed water can be passed from the water source 102. Flow in the line 104 is at high pressure as hereinbefore quantified.

The system 100 further includes the chemical agent dispenser 10 according to the invention, downstream from the feed water source 102. The dispenser 10 is provided as part of a dispenser assembly such as the assemblies 200.1 or 200.2.

The feed water line 104 leads to the dispenser 10. From the dispenser 10 leads a product water line 106 along which a product water stream can be withdrawn from the dispenser 10.

Use and operation of the dispenser 10 is in the manner hereinbefore described to dispense a chemical agent into the feed water stream, thereby to treat the feed water stream and to obtain the product water stream.

Optionally, the system 100 includes a bypass line 105 that bypasses the dispenser 10. The bypass line 105 may be provided by the transfer and bypass conduits 25, 29, or may be provided by a separate line that does not form part of the dispenser 10. In such a case, the dispenser 10 would typically not include the bypass conduit 25 and orifice plates 27.1, 29.1. Of course, it is also possible that the bypass line may be omitted completely.

The system 100 also includes a water filter 112. The filter 112 can be provided downstream of the dispenser 10 or can be integrated with the dispenser 10. The product water line 106 may—as an option—lead directly to a water filter 112. In the event that the filter 112 is employed, a filtered water outlet line 114 leads from the filter 112 along which a filtered water stream can be withdrawn from the filter 112 and also from the system 100. The filter 112 typically comprises a ceramic filter or a membrane filter.

The system may further include, optionally, an acidifier 108 upstream from the water filter 112. The acidifier 108 (i) may be integrated into the artefact, i.e. an acidic agent may be included as a constituent of the artefact, or (ii) may comprise an additional water compartment inside the dispenser 10, or (iii) be provided by a separate dispenser of the same/similar design as the dispenser 10, dispensing acidic agent in the same manner in which the dispenser 10 dispenses chemical agent. From the acidifier leads an acidified water line 110 along which an acidified water stream can be withdrawn from the acidifier 108 to be fed to the filter 112. The acidifier 108 administers an acid to/introduces an acid into the product water stream, thereby to liberate any chlorine that may be present in it. The acid may, in particular, be a solid acid that is dissolvable in water. Typically, the acid is selected from sodium bisulphate, citric acid, malic acid, hydrochloric acid, per-acetic acid.

### Dispenser of FIG. 10

Referring now to FIG. 10, reference numeral 10.1 generally indicates another embodiment of a dispenser in accordance with the invention. The dispenser 10.1 is shown in an open configuration.

In describing the dispenser 10.1, parts of the dispenser 10.1 having a similar function to parts of the dispenser 10 are indicated by the same base reference numerals as were used in FIGS. 1 through 4.

The dispenser 10.1 is particularly for use in dispensing a chemical agent into water flowing along a flow path at an outlet of the flow path, typically at lower pressure conditions than those that apply to the dispenser 10. The dispenser 10.1 is expected to find application particularly in dispensing a chemical agent, e.g. a disinfectant, into drinking water, or in applications in which lower chlorine levels are required, e.g. in wash-down of food.

In particular, the dispenser 10.1, and more particularly an outlet conduit 28.1 defined by an outlet formation 26.1 of the body 12.1, would, in fact, preferably provide the outlet of the flow path.

The dispenser 10.1 has a body 12.1 having a hollow portion 14.1. The hollow portion 14.1 defines a treatment chamber 16.1.

The body 12.1 further has an inlet formation 22.1 defining an inlet conduit 24.1. In use, the flow path would lead into the inlet conduit 24.1 such that the water flowing along the flow path, in operation, is fed into the treatment chamber 16.1.

As indicated above, the body 10.1 also has the outlet formation 26.1 defining the outlet conduit 28.1.

The body 10.1 further has a handle 11 to allow an outlet stream emanating from the outlet conduit 28.1 to be directed manually.

Optionally, a nozzle may be mounted to the outlet formation 26.1. This feature is, however, not illustrated.

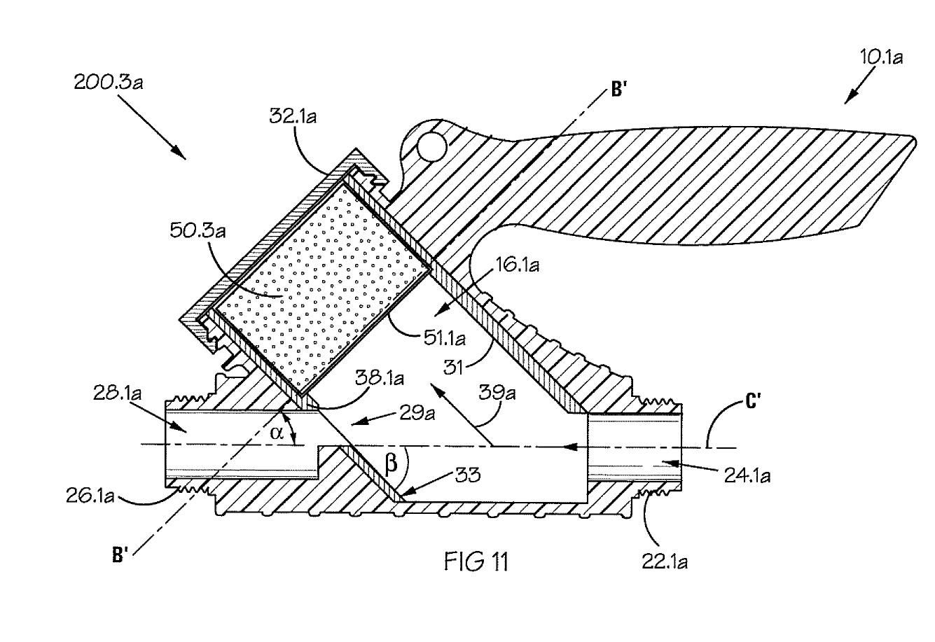

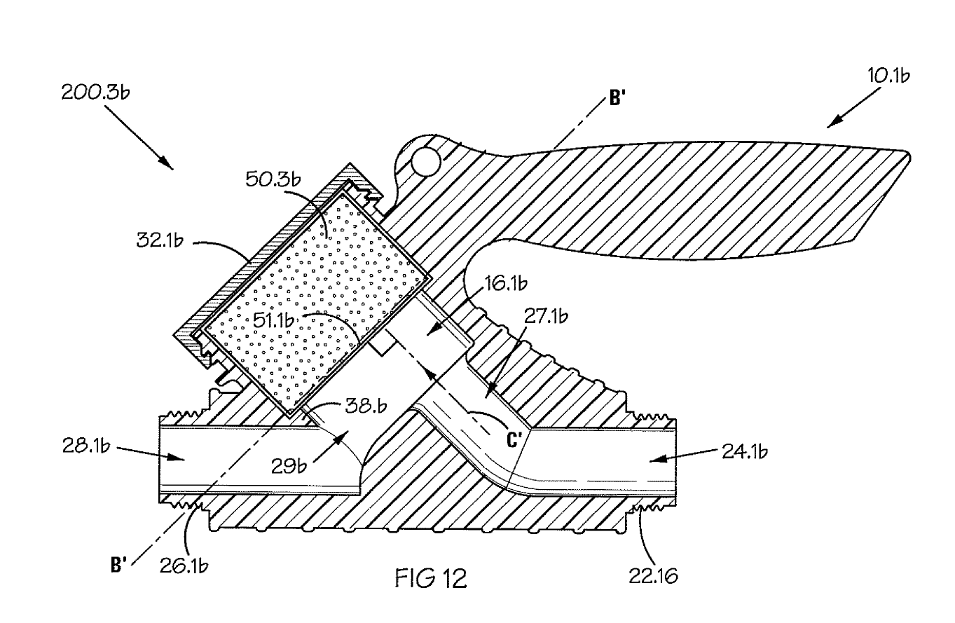

Two forms of the dispenser 10.1, generally indicated by reference numerals 10.1a and 10.1b, are illustrated in sectional side view in FIGS. 10 and 11. In both cases, the dispensers 10.1a and 10.1b are illustrated in closed configurations and as part of respective dispenser assemblies 200.3a, 200.3b in accordance with the invention.

### Forms of the Dispenser of FIG. 10

### Form 10.1a

In the dispenser 10.1a, the treatment artefact access plane B′-B′ extends at an angle a relative to the flow axis C′. The angle α is greater than 0° and smaller than 90°. In the illustrated embodiment, the angle a is 45°.

The plane B′-B′ is defined along an operatively upper surface of a circumferential shoulder 38.1a. The shoulder 38.1a provides a supporting formation on which a chemical agent artefact 50.3a in accordance with the invention, or alternatively one comprising only chemical agent, is supported in a predetermined position inside a housing section of the treatment chamber (not referenced). The housing section is bordered by the shoulder 38.1a and is integral with the body 14.1. An axial end surface of the artefact 50.3a that rests on the shoulder 38.1a in use therefore extends along the plane B′-B′, with the portion of the axial end surface that is exposed to the treatment chamber 16.1a of the dispenser 10.1a being a water contact surface 51.1a of the artefact 50.3a. Optionally, the artefact 50.3a can additionally have a water impermeable cover, as hereinbefore described, applied thereto to ensure water contact with the artefact in the treatment chamber 16.1a is restricted to the water contact surface 51.1a thereof.

The outlet conduit 28.1 has, generally, the same diameter as the inlet conduit 24.1a, but has a narrowed section 29a where it opens into the treatment chamber 16.1a. It will be appreciated that such a configuration causes at least some feed water entering the treatment chamber 16.1a along the inlet conduit 27.1 to accumulate in the treatment chamber 16.1a such that the treatment chamber 16.1a becomes at least partly, and mere typically fully filled with water, in operation.

A circumferential wall 31 of the treatment chamber 16.1a is inclined relative to the flow axis C′ at an angle β of the same magnitude as the angle at which the plane B′-B′ is angled relative to the flow axis C′. This orientation of the chamber 16.1a causes axial inlet flow of feed water entering the treatment chamber 16.1a through the conduit along flow axis C′, or a component thereof, to be diverted in the chamber 16.1a in a direction substantially straight onto the water contact surface 51.1a of the artefact 50.3a. In this manner, water contact with and chemical agent dissolution from the artefact 50.3a along the water contact surface 51.1a across the access plane B′-B′ is driven and the formation of an overdose zone having an obstructively high concentration of chemical agent is avoided by effecting constant water movement adjacent the water contact surface. More particularly, in accordance with the invention, the chamber 16.1a has a wall 33 which is at an angle β relative to the flow axis and diverts at least a part of the flow of feed water entering the chamber 16.1a along the inlet axis C′ toward and onto the access plane B′-B′ and the water contact surface 51.1a in the direction indicated by the arrow 39a.

### Form 10.1b

In the dispenser 10.1b, the treatment artefact access plane B′-B′ extends perpendicularly relative to the flow axis C′, with the inlet conduit 24.1b being oriented such that water entering the treatment chamber 16.1b impinges directly on the water contact surface 51.1b. Feed water contact with the chemical agent artefact 50.3b along the water contact surface 51.1b thereof is therefore driven by water directly impinging on the water contact surface 51.1b, with substantially the full axial inlet flow of feed water along the inlet axis C′ being directed directly onto the water contact surface 51.1b.

Other features of the dispenser 10.1b agree with features of the dispenser 10.1a, although the narrowed section 29b of the outlet conduit 28.1b is of slightly greater diameter than the that of the narrowed section 29a, with an extent of water accumulation, if any, in the treatment chamber 16.1b being less than in the treatment chamber 16.1a.

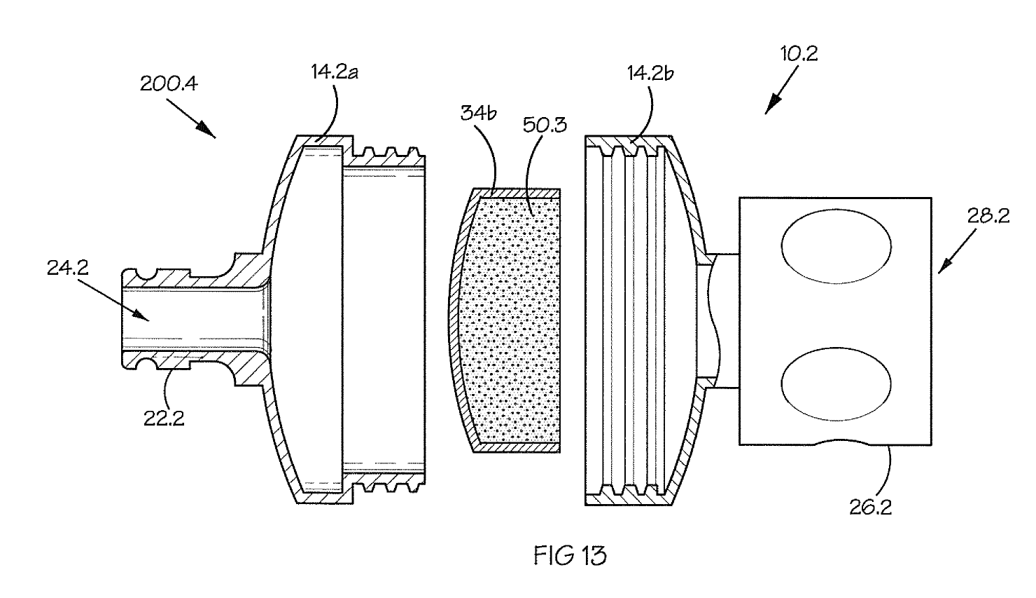

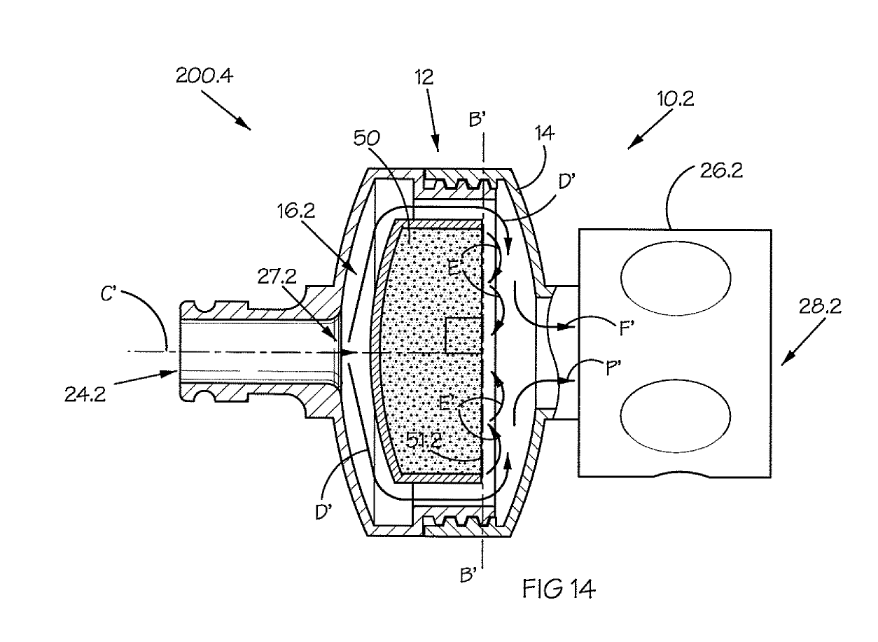

### The Dispenser of FIGS. 13 and 14

In FIGS. 13 and 14, yet another embodiment of a dispenser in accordance with the invention is illustrated, being generally indicated by way of reference numeral 10.2.

The dispenser 10.2 is illustrated as part of another embodiment of a dispenser assembly 200.4. Parts of similar function shared by the dispensers 10, 10.1a, and 10.1b and dispenser 10.2, and by the assemblies 200.1, 200.2 and 200.3 and the assembly 200.4 are again referenced using the same base reference numerals.

The dispenser 10.2 comprises a hollow body 14.2 which comprises upstream and downstream portions 14.2a, 14.2b which have complemental screw threads rendering them securely screwingly engageable to provide the body 14.2. The body 10.2 defines a treatment chamber 16.2.

A chemical agent artefact 50.2 in accordance with the invention, or one comprising only chemical agent, is provided inside the body 10.2. The artefact 50.3 is contained in a housing 34b which is open in a downstream direction and closed in an upstream direction. An upstream end of the housing 34b is convexly rounded.

The body 10.2 has an inlet formation 22 defining an inlet conduit 24.2. The body 10.2 also has an outlet formation 26.2 that defines an outlet conduit 28.2.

With the housing 34b being open in a downstream direction, a water contact surface of the chemical agent artefact 50.2 is also directed, and thus open to the treatment chamber, in a downstream direction. The water contact surface 50.2 is therefore accessible by water inside the treatment chamber 16.2 in a general upstream direction as indicated by the arrow E′.

The access plane B′-B′ along which the water contact surface 51.2 is defined, as well as the water contact surface 51.2, lie across and are perpendicularly oriented with respect to the inlet flow axis C′ along which feed water enters the treatment chamber 16.2 along the inlet conduit 24.2.

With the housing 34b being closed in an upstream direction, feed water entering the treatment chamber 16.2 along the inlet conduit 24.2 does not impinge directly on the chemical agent artefact 50.2. Instead, such impingement is onto the rounded upstream end of the housing 34. Such impingement directs the feed water around the housing 34b, along sides thereof as shown by the arrows D′, toward the outlet conduit 28.2. The applicant has surprisingly found, however, that once the feed water passes a downstream end of the housing 34b, i.e. the end in which the water treatment surface is defined, the flow becomes turbulent adjacent the water contact surface 51.2, as represented by the arrows E′, to such an extent that water passes across the access plane B′-B′, thereby contacting the chemical agent artefact 50.2 and dissolving chemical agent from it, thereby dispensing chemical agent into the water that leaves the treatment chamber 16.2. In fact, it appears that the turbulence, and if not the turbulence itself then the turbulence assisted by back pressure from the outlet conduit 28.2 due to accumulation of some water in the treatment chamber 16.2, is sufficient to drive dissolution of chemical agent from the chemical agent artefact 50.2 in a generally upstream direction.

### EXAMPLES OF CHEMICAL AGENT ARTEFACTS SUITABLE FOR USE IN THE DISPENSERS OF THE PRESENT INVENTION

A preferred embodiment of a chemical agent artefact suitable for use in the dispenser 10 according to the present invention, particularly when employed in a system operating under high pressure as described, is prepared comprising, as chemical agent, calcium hypochlorite between about 20% and about 50% by mass of the artefact, more preferably between about 25% and about 30%.

Further, the artefact comprises, by mass, between about 50% and about 80% of calcium phosphate as structuring agent, both values inclusive. More preferably, the artefact comprises, by mass, between about 55% and about 65% of the calcium phosphate.

Still further, the artefact comprises, by mass, between about 1% and about 10% of the sodium chloride as chemical agent liberating agent, both values inclusive. More preferably, the artefact comprises, by mass, between about 5% and about 10% of the sodium chloride.

The calcium hypochlorite may optionally be substituted with SIDC.

In an embodiment of the invention in which citric acid is used as liberating and/or pH control agent, or for whichever other purpose, the artefact may comprise, by mass, from 15% to 35%, preferably 25%, calcium hypochlorite, from 15% to 35%, preferably 25%, citric acid and from 40% to 60%, preferably 50%, calcium phosphate.

The artefact can also comprise, by mass, from about 1% to about 2% sodium tripolyphosphate (STPP) as wetting agent.

The Applicant has found that there is a critical ratio of calcium hypochlorite to calcium phosphate below which water finds resistance in connecting pathways and/or channels between the calcium hypochlorite granules within the artefact. The distance between individual particles of calcium hypochlorite, combined with the fact that calcium phosphate is insoluble and is able to cut off water flow between these particles, could result in the calcium phosphate cutting water access off completely between individual calcium hypochlorite particles or particle clusters, with no active ingredient thus being released. The same effect is observed when the tablet itself becomes too large, or too thick. In this event, and as the calcium hypochlorite nearest the outer surface of the tablet dissolves, the water eventually has too far to travel from the outside of the tablet to the calcium hypochlorite stored deeper inside, also resulting in no further active ingredient being released.

The Applicant has surprisingly found that to overcome these difficulties in instances where a larger tablet may be needed or where the pressure is relatively high and the end user needs lower chlorine levels, the level of calcium hypochlorite may be effectively reduced below the critical ratio at which the calcium phosphate blocks dissolution through the addition of table salt (NaCl) in accordance with the invention. The salt provides the necessary solubility pathways that will allow the chlorine to keep dissolving even when very low levels are needed. In another embodiment of this concept, the salt may be combined with—or even replaced by—a suitable dry but similarly soluble granular acid compound (such as citric acid) in order to simultaneously lower the pH of the water while providing water access between the calcium hypochlorite particles in the tablet blend. The advantage of this is that the active ingredient released, namely hypochlorous acid, should ideally be applied when water pH is between pH 7.0 and 7.8.

For lower pressure applications, in all of the dispensers 10, 10.1a, 10.1b and 10.2, the calcium hypochlorite concentration may be higher: typically in the order of 80%-100%. No structuring agent would then typically be employed.

In one embodiment, typically applicable to environmental hygiene and disinfection (non-food surfaces) either calcium hypochlorite or SDIC can be used between 80% and 100%, blended with NaCl in concentration 1%-15%, citric acid in concentration 1%-10% and sodium tripolyphosphate in concentration 1%-7%.

In another embodiment, relevant to food surfaces, the SDIC would be omitted.

In yet another embodiment, when disinfecting potable water, no SDIC, citric acid or STPP would be employed.

In most cases, an inert binder and/or excipient could be employed. One suitable material for this purpose is hydrated lime. The binder/excipient can be used in concentration up to 5%, depending on the source of the material.

### DISCUSSION

The applicant has found that the present invention, in toto, provides a unique and particularly advantageous approach to the exploitation of calcium hypochlorite, in particular, but also other chemical agents, not only for water treatment purposes, but also for exploiting dissolvable chemicals, such as fertilizers, in solution. This approach is regarded as addressing, in particular, the difficulties and disadvantages generally associated with such exploitation as hereinbefore explained. Whilst the invention is expected to find application in relation to other chemical agents than calcium hypochlorite, the discussion herein is with reference to calcium hypochlorite as preferred chemical agent.

In particular, the applicant has found that the chemical agent artefact according to the invention allows for the achievement of useful and long-term exploitation of sufficiently low quantities of calcium hypochlorite to achieve acceptable/desirable treatment levels in calcium hypochlorite-product water, particularly in high pressure applications. The inclusion of the dissolvable salt or similarly soluble dry pH reducing chemical in the artefact as a liberating agent is considered a particularly important and unique feature in this regard, in that it allows for the formation of a sufficiently open network of calcium hypochlorite access pathways in the artefact for the calcium hypochlorite content of the artefact to be fully exploited, particularly where low concentrations of chlorine are required. As has been indicated, in the Applicant's experience a threshold calcium hypochlorite/calcium phosphate concentration exits beyond which it will not be possible fully to exploit a lower concentration of calcium hypochlorite from the artefact, as the network of calcium hypochlorite pathways formed will not be sufficiently open to allow access to substantially all of the calcium hypochlorite in the artefact. The applicant has found that such an approach allows for lower concentration/proportions of chemical agent to be contained in the artefact without compromising chemical agent leading efficiency. In this manner, enhanced control of chemical agent dispensing at low concentrations is enabled. The employment of the liberating agent therefore allows for the artefact to contain desirably low concentrations of the chemical agent relative to the structuring agent, whilst still being effective in delivering, by dissolution, the chemical agent to water that is to be treated. Water access to the chemical agent is therefore not impeded by excessive quantities of structuring agent making up for the difference between higher and lower concentrations of chemical agent.

Additionally, in relation to the artefact, the applicant has surprisingly found that the controllability of concentrations of calcium hypochlorite that can be advantageously exploited according to the present invention and the correspondingly low concentrations of calcium hypochlorite thus required in the artefact according to the invention could obviate a requirement for the artefact according to the invention to be classified as a dangerous chemical by virtue of its calcium hypochlorite content. This will, in the Applicant's experience, be associated with greater simplicity in transport and storage of a calcium hypochlorite-containing product.

The applicant has also found that the dispenser according to the invention, by restricting liquid contact with a chemical agent artefact to a water contact surface comprising a, preferably planar, part of the outer surface of the artefact, dispensing of a chemical agent from an artefact comprising the chemical agent is done more effectively, efficiently and fairly simply in comparison to more complicated previous approaches. As described, by limiting the extent of water contact with the artefact and by in fact restricting water contact to a single water contact surface of the artefact extending along the access plane, and further by directing such contact and driving dissolution in the various ways that have been described, the applicant has found that dissolution of chemical agent from such an artefact can achieved in an even and progressive manner.

As regards the water treatment system according to the invention, the applicant has found that the employment of the acidifier in combination with the treatment dispenser according to the invention renders the system useful particularly in the medical field and would enable the exploitation of calcium hypochlorite in a non-harmful manner in medical applications. Application thereof is expected to extend to foodstuff disinfection and environmental hygiene.

Thus, as has been stated, the Applicant has found that the present invention usefully and advantageously addresses the difficulties and challenges generally associated with attempting to achieve versatile exploitation of calcium hypochlorite in water treatment applications.

1. A dispenser to dispense, in operation, particulate, soluble chemical agent, by dissolution, from a compacted or compressed form thereof, into liquid that flows along a flow path, the dispenser comprising
a body defining a liquid treatment chamber;
an inlet to the liquid treatment chamber, through which inlet feed liquid can, in operation, continuously be fed into the treatment chamber; and
an outlet from the treatment chamber, through which outlet product liquid, containing dissolved chemical agent can, in operation, continuously leave the treatment chamber, the dispenser being configured such that a chemical agent artefact comprising the particulate, soluble chemical agent in a compacted or compressed form is arrangeable in the dispenser, in use, in a predetermined position in which the artefact is exposed to or accessible from inside of the treatment chamber only along a liquid contact surface provided by part of an outer surface thereof, which part extends along an artefact access plane defined in the dispenser in use at the predetermined position, such that the feed liquid which is fed to the treatment chamber through the inlet, in operation, can contact the artefact only along the liquid contact surface and necessarily by passing across the artefact access plane.

2. The dispenser according to claim 1, which is configured such that some of the feed liquid that is continuously fed to the chamber collects, in operation, inside the chamber, such that, in operation, there is virtually constant liquid contact with the artefact along the liquid contact surface.

3. The dispenser according to claim 1 or claim 2, in which the liquid contact surface is provided by a single face of the artefact extending along a single plane, being the artefact access plane.

4. The dispenser according to claim 1 or claim 2, which has a chemical agent artefact supporting formation which supports, in use, directly or indirectly, the chemical agent artefact such that the water contact surface is exposed to or accessible from inside of the treatment chamber only along the liquid contact surface.

5. The dispenser according to claim 4, in which the supporting formation defines a support plane which is, in use, parallel to or co-planar with the access plane.

6. The dispenser according to claim 4, in which the supporting formation is provided by an artefact housing which encloses, in use, the artefact in such a manner that it is exposed to or accessible from the treatment chamber only along the water contact surface.

7. The dispenser according to claim 6, in which the housing is at least partly provided by the body.

8. The dispenser according to claim 6, in which the housing is a removable part of the dispenser.

9. The dispenser according to any of claims 1 to 8 inclusive, which is configured such that the access plane extends, in use, substantially parallel to or co-linearly with an inlet flow axis along which feed liquid passes through the inlet into the liquid treatment chamber.

10. The dispenser according to claim 2 and claim 9, in which the access plane lies across and substantially perpendicular to an upstream projection of an outlet flow axis along which liquid leaves the treatment chamber, in operation, with back pressure in a flow line defining the flow path driving dissolution of chemical agent from the chemical agent artefact.

11. The dispenser according to any of claims 1 to 8 inclusive, which is configured such that the artefact access plane extends, in use, at an angle greater than 0° and smaller than 90° to an inlet flow axis along which feed liquid passes through the inlet into the liquid treatment chamber and is spaced from the flow axis such that it the liquid contact surface does not lie across the inlet flow axis, in use.

12. The dispenser according to claim 2 and claim 11, in which the treatment chamber has a wall configured to direct, in operation, at least a part of the inlet flow of feed water entering the treatment chamber along the inlet flow axis away from the inlet flow axis, substantially straight toward the access plane and the liquid contact surface, for such diverted inlet flow or a component thereof, in operation, to drive dissolution of chemical agent from the chemical agent artefact and to disperse treatment agent accumulated adjacent the liquid contact surface.

13. The dispenser according to any of claims 1 to 8 inclusive, which is configured such that the artefact access plane extends, in use, substantially perpendicularly to an inlet flow axis along which feed liquid passes through the inlet into the liquid treatment chamber.

14. The dispenser according to claim 13, in which the artefact access plane and the liquid contact surface face in a downstream direction with respect to a direction in which feed liquid enters the treatment chamber, in operation, with a facing direction of the access plane being into a direction from which liquid access across it from the treatment chamber occurs, in operation.

15. The dispenser according to claim 13 or claim 14, in which the artefact access plane and the liquid contact surface lie across a downstream projection of the inlet flow axis.

16. The dispenser according to claim 14, in which the body is configured such that the artefact is, in use, arrangeable in the treatment chamber in a downstream-open housing, such that liquid entering the treatment chamber through the inlet, in operation, impinges on a closed upstream end of the housing and passes along sides of the housing toward the outlet, thereby resulting in turbulent flow occurring adjacent a downstream side of the access plane, which turbulent flow, at least in part, drives dissolution of the chemical agent from the artefact in an upstream direction in operation.

17. The dispenser according to any of claims 1 to 16 inclusive, in which the artefact is partly covered by an artefact covering layer, which layer is liquid impervious and exposes only the liquid contact surface.

18. The dispenser according to any of claims 1 to 17 inclusive, which includes, in use, a liquid pervious member adjacent the liquid contact surface such that liquid contact with the liquid contact surface occurs, in operation, through the liquid pervious member.

19. The dispenser according to claim 18, in which the liquid pervious member extends across the whole of the liquid contact surface such that liquid contact with the liquid contact surface, in operation, occurs only though the liquid pervious member.

20. The dispenser according to any of claims 1 to 19 inclusive, which includes the chemical agent artefact and in which the artefact is fully erodible through dissolution, with the artefact comprising a major proportion of dissolvable material, a major proportion of which is made up of the chemical agent.

21. The dispenser according to any of claims 1 to 19 inclusive, which includes the chemical agent artefact and in which the artefact comprises an admixture of a particulate liquid insoluble artefact structuring agent providing an artefact matrix; and
a particulate liquid-soluble chemical agent embedded in the artefact matrix.

22. The dispenser according to claim 21, in which the structuring agent comprises calcium phosphate and/or calcium sulphate.

23. The dispenser according to claim 21 or claim 22, in which the chemical agent artefact comprises a particulate soluble liberating agent that is non-reactive in the liquid with the chemical agent and dissolution of which from the artefact increases the porosity of the artefact for liquid to access and dissolve from the artefact the chemical agent.

24. The dispenser according to any of claims 1 to 23 inclusive, in which the liquid is water and the chemical agent is selected from sodium chlorate, sodium bisulphate, calcium chloride, sodium dichloro-iso-cyanurate (NaDCC), citric acid, chlorine dioxide, sodium bicarbonate, sodium hydroxide, sodium dichloroisocyanurate (SDIC), and calcium hypochlorite.

25. A liquid treatment system to dispense, in operation, particulate, soluble chemical agent into liquid that flows along a flow path, the system including
flow path defining means providing a flow line and defining the flow path, a flow path inlet to and a flow path outlet from the flow path; and
a dispenser in accordance with any of claims 1 to 24, the dispenser being arranged in the flow path between the flow path inlet and the flow path outlet, such that, in operation, feed liquid flowing along the flow path continuously feeds into the treatment chamber of the dispenser along the inlet thereto, with at least some of the feed liquid contacting a chemical agent artefact arranged in the dispenser, in use, across the access plane along the liquid contact surface thereof, thereby to dissolve chemical agent from the artefact into the feed liquid to obtain product liquid which is continuously withdrawn from the treatment chamber along the outlet therefrom.

26. The system according to claim 25, in which the dispenser is a dispenser according to claim 2.

27. The system according to claim 26, in which the flow line is a high pressure flow line at a pressure of at least 4 bar.

28. The system according to claim 27, in which the dispenser is a dispenser according to claim 9 or claim 10, with back pressure in the flow line, in operation, driving dissolution of chemical agent from the artefact across the access plane.

29. The system according to claim 26, in which the dispenser is a dispenser according to claim 11 or claim 12, with dissolution of chemical agent from the artefact being driven, in operation, by diverted inlet flow of feed liquid, or a component thereof, originating from axial inlet flow of feed liquid entering the treatment chamber along the inlet axis through the inlet thereto and being diverted from the inlet axis toward and directly onto the water contact surface and access plane.

30. The system according to claim 25, in which the dispenser is a dispenser according to claim 13, with direct impingement of feed water flow along the inlet axis through the inlet into the treatment chamber onto the access plane and water contact surface, in operation, driving dissolution of chemical agent from the artefact across the access plane.

31. The system according to claim 25, in which the dispenser is a dispenser according to claim 16, with turbulent flow adjacent a downstream side of the access plane, at least in part, driving dissolution of the chemical agent from the artefact.

32. The dispenser according to any of claims 1 to 24, in use.

33. The dispenser according to any of claims 1 to 24, in operation.

34. A method of dispensing a particulate, soluble chemical agent by dissolution from a compacted or compressed form thereof into liquid flowing along a flow path, the method including
feeding feed liquid along a flow path into a liquid treatment chamber which has an inlet, an outlet, and a chemical agent artefact comprising particulate, soluble chemical agent in a compacted or compressed form, such that at least some of the feed liquid contacts the artefact from inside the treatment chamber along a water contact surface thereof which is exposed to or accessible from inside of the treatment chamber and is provided by a part of an outer surface of the artefact that extends along and is necessarily accessible across an artefact access plane, with at least some of the feed liquid passing across the access plane and dissolving chemical agent from the artefact, thereby dispensing chemical agent from the artefact by dissolution into the feed liquid and obtaining product liquid; and
allowing product liquid comprising dissolved chemical agent to leave the treatment chamber through the outlet.

35. The method according to claim 34, in which the flow path is defined by a high pressure line and which includes feeding feed liquid into the treatment chamber in a direction along an inlet flow axis parallel to or co-linear with the access plane and allowing liquid to accumulate inside the treatment chamber such that, whilst there is flow along the flow path, water contact with the chemical agent artefact along the water contact surface is virtually constantly maintained, and driving dissolution of chemical agent from the chemical agent artefact across the access plane and the water contact surface by means of back pressure in a the high pressure line.

36. The method according to claim 34, which includes feeding feed liquid into the treatment chamber in a direction along an inlet flow axis at greater than 0° and smaller than 90° to the access plane and allowing liquid to accumulate inside the treatment chamber such that, whilst there is flow along the flow path, water contact with the chemical agent artefact along the water contact surface is virtually constantly maintained, and driving dissolution of chemical agent from the chemical agent artefact across the access plane and the water contact surface by diverting inlet flow of feed water, or component thereof, from axial inlet flow of liquid into the treatment chamber through the inlet along the inlet flow axis toward the access plane and the water contact surface.

37. The method according to claim 34, which includes feeding feed liquid into the treatment chamber in a direction along an inlet flow axis that is substantially perpendicular to the access plane and driving dissolution of chemical agent from the chemical agent artefact across the access plane and the water contact surface by means of direct flow impingement of feed water on the water contact surface along the inlet axis.

38. The method according to claim 34, which includes feeding feed liquid into the treatment chamber in a direction along an inlet flow axis that is substantially perpendicular to the access plane, the access plane facing in a downstream direction relative to the direction of flow, and driving dissolution of chemical agent from the chemical agent artefact across the access plane and the water contact surface by means of upstream turbulence adjacent a downstream side of the access plane.
